(19) United States
(12) Patent Application Publication
(10) Pub. No.: US 2002/0118920 A1
(43) Pub. Date: Aug. 29, 2002

(54) Multi-port optical filtering glass package and method of manufacture thereof

(76) Inventors: Kurt R. Francis, Yuma, AZ (US); Charles X. W. Qian, Cupertino, CA (US)

Correspondence Address: LEONARD TACHNER, A PROFESSIONAL LAW CORPORATION, 17961 SKY PARK CIRCLE, SUITE 38-E, IRVINE, CA, 92614-6364, US

(21) Appl. No.: 09/791,170

(22) Filed: Feb. 26, 2001

(51) Int. Cl. G02B 6/32

(52) U.S. Cl. 385/33; 385/27; 385/78

(57) ABSTRACT

An optical filtering assembly used in temperature compensated multi-port filtering or isolating packages is described. The optical path comprises multiple optical glass fibers inserted into a multi-capillary glass ferrule to produce a fiber-ferrule subassembly, a collimating lens, at least one spectral shaping glass filter and a reflecting element assembly. The collimating lens collimates the light emitted from the input optical fiber into parallel rays, which hit the filter element. Each filter splits the collimated light into two beams. The first (transmitted) beam is spectrally modified as it passes through the filter element, then reflects off the reflecting element traveling back through the same filter element, again spectrally modifying the transmitted beam. Then the beam passes back through the collimating lens in the opposite direction, and couples into the pass band fiber. The second reflective beam is reflected from the filter element through the lens into the reflective optical fiber. The optical components are assembled and aligned so that the transmitted and reflected light beams are collimated and their insertion losses are minimized. Examples of 2-fiber, 3-fiber, 4-fiber and 5-fiber packages are disclosed.

### BACKGROUND OF THE INVENTION

1. Field of the Invention

The present invention relates to optical filtering and isolating packages, including dense and coarse wavelength division multiplexing (DWDM & CWDM) devices in general, and more specifically to multi-port filtering devices. The invention relates also to the manufacture of these devices with adhesive bonding processes.

2. Prior Art

Multiple-port, filtering and isolating packages are widely used in local and long distance optical telecommunication networks. These networks comprise various spectral shaping and isolating optical filter assemblies as parts of dense wavelength division multiplexing (DWDM) systems. The need to design reliable filters for such systems, which are subject to various thermal and mechanical loads during their 20 to 25 year lifetime, is of significant importance. A typical filter assembly comprises two (input and output) optical glass fibers inserted into a dual-capillary ferrule to produce a fiber-ferrule sub-assembly, a gradient index (GRIN) lens; and a spectral shaping (isolating) glass filter(s). The optical components of the assembly are embedded into an isolating glass tube, which, in turn, is mechanically protected by the metal housing (enclosure). In a typically multi-port package, the dual-fiber filter assembly is combined with the output collimating assembly leading to a single optical fiber. Such filter assemblies have been known to exhibit excessive insertion losses due to the coupling of the input fibers to the ferrule and the subsequent alignment of the collimator to the spectral shaping or isolating filter. Such losses have been higher than desired, resulting in degraded overall performance of the system particularly during exposure to ambient operating conditions.

In prior art systems input glass ferrules employ one of two major designs. Either a single capillary of elliptical cross section or separate circular capillaries have been used, each with relatively short (1.8 mm) fiber-receiving ends. With such input ferrules, the optical fiber is subjected to an S-bending over the short conical end portion, which typically exceeds 50% of the fiber diameter (for a fiber having a 125 μm diameter on a span of about 12 to 15 diameters in length). This excessive micro-bending increases the insertion losses. Although the dual-capillary design reduces the lateral deflection of the fiber interconnects compared to the elliptical single-capillary design, the short length of the cone end of such ferrules cannot reduce the micro-bending of the fiber and its inherent insertion loss. Fiber-ferrules subassemblies employing such ferrules are manufactured by the steps of: Fabricating the ferrules to hold the optical fibers (1); inserting the optical fibers stripped of their polymer coating into the respective ferrule capillaries (2); epoxy bonding them into the ferrule capillaries, including the conical end portions (3); grinding an 8⁰ facet of the fiber-ferrule (4); polishing the facet (5) and depositing on the polished surface an antireflection (AR) coating. Once finished, the fiber-ferrule is aligned and assembled with the GRIN or ball lens collimator, whose surface is coated with antireflection (AR) films and then embedded into the insulating glass tube which, in turn, is protected by a metal housing to provide structural integrity, robustness and thermal insulation to the assembly.

There are two different technical solutions used in the design of bonds securing the components of a filter assembly. A low compliance bond between thermally well-matched fibers and ferrule is an approach commonly used by a majority of manufacturers. The adhesives used are heat-curable epoxies with high Young's modulus (E>10,000 psi) and moderate to high thermal expansion coefficients (∝=40 to 60 10^{-6 0}C⁻¹). A typical example would be 353ND Epo-Tek epoxy adhesive. In addition, the bond thickness used is very small.

Silicon adhesives are used to bond thermally mismatched glass tubes with metal housings and glass filters with metal holders. In these joints, a high compliance design is used. The silicones, which can be cured between 20-150 degrees Celsius in the presence of moisture, are typically characterized by an extremely low Young's Modulus (E<500 psi) and high thermal expansion (∝=180 to 250 10^{-6 0}C⁻¹). A typical example would be DC 577 silicone, which can be used to bond a metal filter holder to a GRIN lens.

Adhesive bonding with subsequent soldering or welding is required to encapsulate a filtering assembly into a three-port package or DWDM device. A precise alignment achieved during initial assembly of a filter prior to final packaging, can be easily decreased due to the high temperature thermal cycle associated with soldering or welding during packaging of the component. Such prior art manufacturing processes and resulting components have several problems resulting from the fact that the optical components experience stresses due to the thermal contraction mismatch between the glass and metal materials; polymerization shrinkage in adhesive bonds; and structural constraints induced by bonding and final soldering during encapsulation. These stresses lead to displacements of optical components during bonding and soldering, resulting in 0.3 to 1.0 dB increase in the insertion loss.

Such a filter package enclosure which is typically formed of six to eight concentric proactive units, has micron transverse tolerances. Maintaining these tolerances requires precision machining, time-consuming alignment, and soldering with frequent rework. As a result of these limitations, the optical performance specifications are lowered and cost is increased. As an example, soldering typically includes several re-flow cycles. This induces local thermal stresses in the nearby adhesive bonds and leads to the degradation of the polymer adhesive, resulting in repositioning of optical components and a shift of the spectral filter performance. With such designs, soldering may also result in the contamination of optical components through direct contact with molten solder and/or flux.

Although both the collimating subassemblies and housings are cylinders, the alignment of commercially available optical components, which exhibit a random distribution of optical and structural characteristics, requires some lateral and angular repositioning of the subassemblies. This repositioning of the optical subassemblies is limited by the gap in the solder joint and the ratio of this gap to the length of the subassembly. The lateral and angular repositioning observed in some isolators can be as high as 0.05 to 0.3 mm and 0.5 to 1.5⁰, respectively. The soldering of non-capillary gaps meets well-known difficulties, such as high volume shrinkage of the solder, void formation and contamination of optical components.

However, for many applications, it is desirable to obtain a high accuracy thermally compensated filtering or isolating three-port package that can be relatively inexpensive and reliable. Additionally, a package design should be adequate not only to mechanically protect the fragile optical components, but also to compensate for and minimize the thermally-induced shift in spectral performance. Thus, there exists a need for a process for manufacturing a filtering (or isolating) multi-port package, which has a construction which is miniaturized, has a low insertion loss, is inexpensive to manufacture, and which results in a filtering (or isolating) multi-port package having reliable, long-term operation.

### SUMMARY OF THE INVENTION

An optical filtering assembly used in temperature compensated multi-port filtering or isolating packages is described. The optical path comprises multiple optical glass fibers inserted into a multi-capillary glass ferrule to produce a fiber-ferrule subassembly, a collimating lens, at least one spectral shaping glass filter and a reflecting element assembly. The collimating lens collimates the light emitted from the input optical fiber into parallel rays, which hit the filter element. The filter splits the collimated light into two beams. The first (transmitted) beam is spectrally modified as it passes through the filter element, then reflects off the reflecting element traveling back through the same filter element, again spectrally modifying the transmitted beam. Then the beam passes back through the collimating lens in the opposite direction, and couples into the pass band fiber. The second reflective beam is reflected from the filter element through the lens into the reflective optical fiber. The optical components are assembled and aligned so that the transmitted and reflected light beams are collimated and their insertion losses are minimized.

The inventive optical filtering assembly includes three aligned and bonded parts. The first part comprises the fiber-ferrule telescopically embedded into the thermally and structurally matched insulating and protective glass tube. The collimating lens is also telescopically embedded into the thermally and structurally matched insulating and protective glass tube such that the location of the fiber-ferrule yields collimated light. A second assembly part comprises the filter or filters bonded to a thermally matched glass holder. This second assembly is aligned to minimize insertion loss and guide the reflected beam into the reflective fiber. Each filter is adhesively bonded to a holder assembly and aligned to minimize insertion loss and guide the reflected band into the reflective fiber. The third assembly part comprises the reflecting element bonded to a thermally matched glass holder. The reflecting element is aligned to minimize insertion loss and guide the transmitted band back through the filter and into the pass band fiber. An outer enclosure tube and plug are placed around the internal optical chain and adhesively bonded into position. The protective tubes used in all parts are made from thermally matched glass material. A thermally and/or UV curable adhesive with low moisture diffusivity is used in these telescopic and/or ball in socket joints. The parts are aligned to minimize the insertion losses (IL) in the transmitted and reflected light beams. To retain the achieved alignment, the ball in socket adhesive joint is formed at the collimating lens-filter element interface and at the filter reflecting element interface. To minimize the thermal excursion and re-positioning of the optical components in this joint, the adhesive is applied to form a thin ring layer, which is symmetrical about the optical axis of the package regardless of the angular position of the filter or reflecting element. The width of the ring layer is limited to cover the contact edges of the glass tube and the outer diameter of the filter and collimating lens (maintaining an epoxy free light path). To provide the full a-thermalization of the assembly, all components, including the filter substrate, are made from thermally well-matched glasses and a thermally and/or UV curable adhesive with low moisture diffusivity are used in all joints.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a cross-sectional view of a first embodiment of a 3-fiber configuration of the invention;

FIG. 2 is a cross-sectional view of a second embodiment of a 3-fiber configuration;

FIG. 3 is a cross-sectional view of a 2-fiber configuration;

FIG. 4 is a cross-sectional view of a 4-fiber configuration; and

FIG. 5 is a cross-sectional view of a 5-fiber configuration.

### DETAILED DESCRIPTION OF PREFERRED EMBODIMENTS

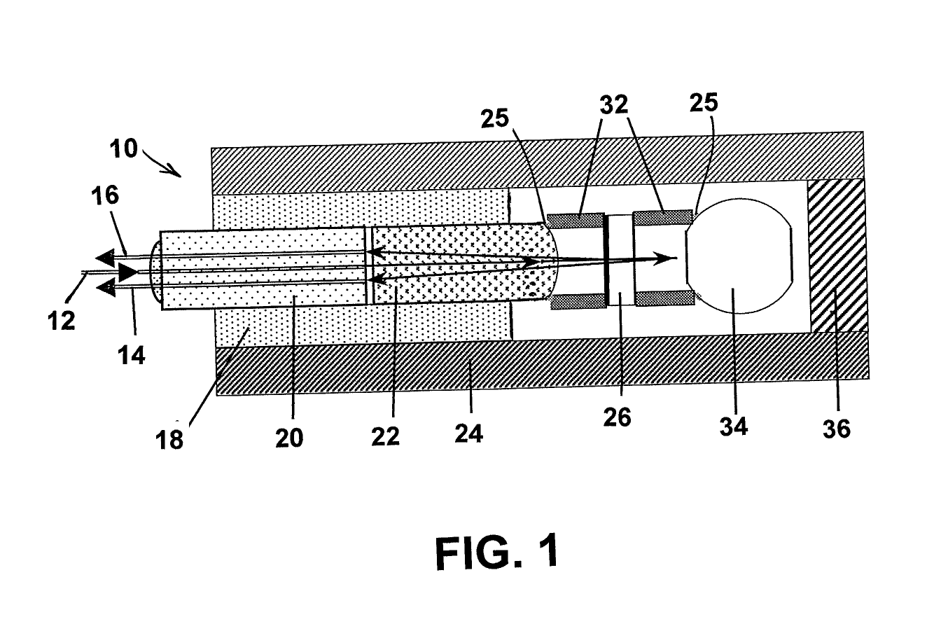

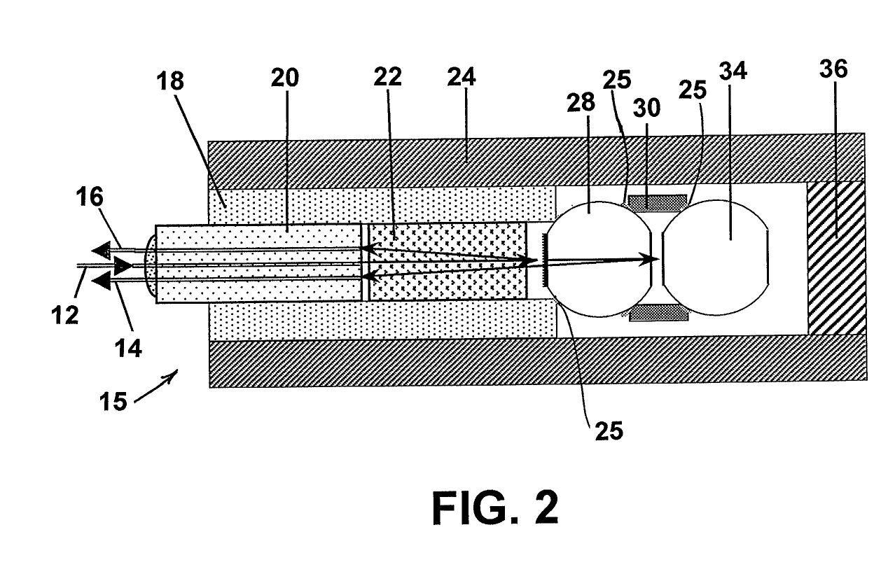

Referring now to FIGS. 1 through 5, it will be seen that the illustrated embodiments employ many identical components and similar structures. Reference numerals for identical components in the respective embodiments are the same. An optical filtering assembly used in the temperature compensated multi-port filtering or isolating packages is described in conjunction with FIGS. 1 and 2. The optical path is comprised of three optical glass fibers, input fiber 12, reflective fiber 16, and passband fiber 14 inserted into a tri-capillary glass ferrule 20 to produce a fiber-ferrule subassembly, a collimating (GRIN or aspheric) lens 22, a spectral shaping glass filter (26 in FIG. 1, 28 in FIG. 2) and a reflecting element 34 assembly. The lens 22 collimates the light emitted from the input optical fiber 12 into parallel rays, which hit the filter element (26 in FIG. 1; 28 in FIG. 2). The filter splits the collimated light into two beams. The first (transmitted) beam is spectrally modified as it passes through the filter element, then reflects off the reflecting element 34 traveling back through the same filter element, again spectrally modifying the transmitted beam. Then passing back through the collimating lens 22 in the opposite direction, and couples into the pass band fiber 14. The second reflective beam is reflected from the filter element (26 or 28) through the lens into the reflective optical fiber 16. The optical components are assembled and aligned so the transmitted and reflected light beams are collimated and their insertion losses (IL) are minimized.

The optical filtering assembly (10 in FIG. 1; 15 in FIG. 2) includes three aligned and bonded parts. The first part is the fiber-ferrule 20 telescopically embedded into the thermally and structurally matched insulating and protective glass tube 18. A lens 22 that is also telescopically embedded into the thermally and structurally matched insulating and protective glass tube embedded into the thermally and structurally matched insulating and protective glass tube 18 such that the location of the fiber-ferrule 20 yields collimated light. The second assembly part is the filter (26 or 28) bonded to a thermally matched glass holder (32 in FIG. 1; 30 in FIG. 2). This is aligned to minimize insertion loss and guide to reflected band into reflected fiber 16. The third assembly part is the reflecting element 34 bonded to a thermally matched glass holder (32 in FIG. 1; 30 in FIG. 2). This is aligned to minimize insertion loss and guide the transmitted band back through the filter (26 in FIG. 1; 28 in FIG. 2) and into the pass band fiber 14. An outer enclosure tube 24 and plug 36 are placed around the internal optical chain and adhesively bonded into position. The protective tubes used in all parts (18, 24, 36, 30, 32), are made from the thermally well-matched glass material. A thermally and/or UV curable adhesive with low moisture diffusivity is used in these telescopic and/or ball in socket joints. The parts are aligned to optimize both the insertion losses (IL) in the transmitted and reflected light beams. To retain the achieved alignment, the ball in socket adhesive joint is formed at the collimating lens 22—filter element interface and at the filter reflecting element interface (32 in FIG. 1; 30 in FIG. 2). To minimize the thermal excursion and re-positioning of the optical components in this joint, the adhesive is applied to form a thin ring layer 25, which is symmetrical about the optical axis of the package regardless of the angular position of the filter or reflecting element. In addition to this, the width of the ring layer 25 is limited to cover the contact edges of the glass tube and the outer diameter of the filter and collimating lens (maintaining an epoxy free path). To provide the full a-thermalization of the assembly, all components, including the filter substrate, are made from thermally well-matched glasses and a thermally and/or UV curable adhesive with low moisture diffusivity used in all joints for layer 25 in FIGS. 1 and 2.

The embodiment of FIG. 1 will accommodate the packaging of any filter element. The embodiment of FIG. 2 requires a spherically shaped filter element. Both designs serve the same function, but with universal and unique filter configurations, respectively.

The embodiment of FIG. 1 is primarily for industry standard cubic filter elements whereas the embodiment of FIG. 2 is for a new generation package using a reduced ii stress filter element to improve environmental stability.

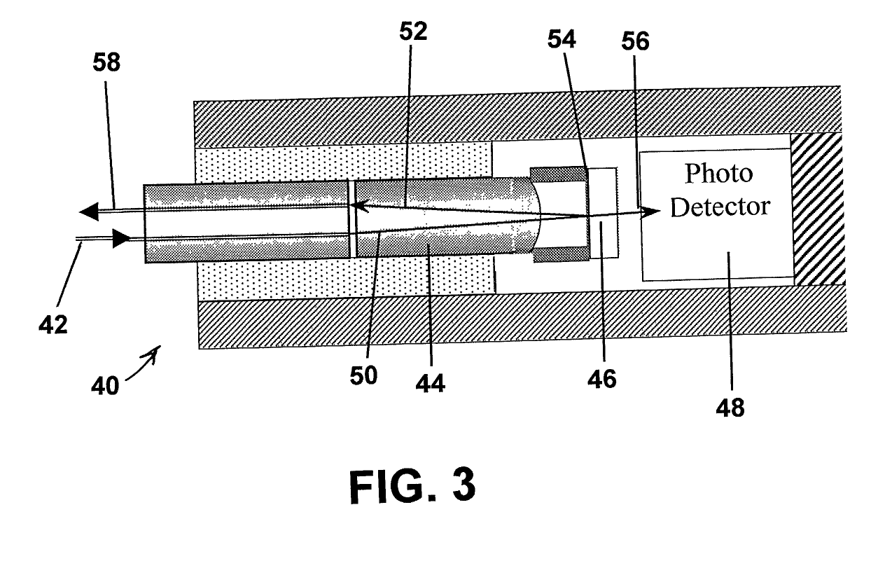

The unique structure described herein is highly advantageous for use in many optical applications and is not limited to a 3-fiber package. By way of further example, FIG. 3 illustrates a 2-fiber package in the form of a tap power monitor 40. Current tap power monitors are comprised of a pigtailed photo diode, and a tap coupler. The inventive embodiment of FIG. 3 illustrates the integration of these two common devices into a single package. Light is input from 42, passes through collimating lens 44 and contacts a partial reflecting element 54. A filter element 46 is aligned such that the reflected beam 52 is directed back through the collimating lens 44 and into the output fiber 58. The transmitted beam 56 is detected by the photo detector 48. Other designs of two port optical devices using this inventive configuration include Splitter-Tap Monitor, Isolator, VOA, ASE or GFF filter, Faraday rotator, Wavelength locker, Dispersion Compensator.

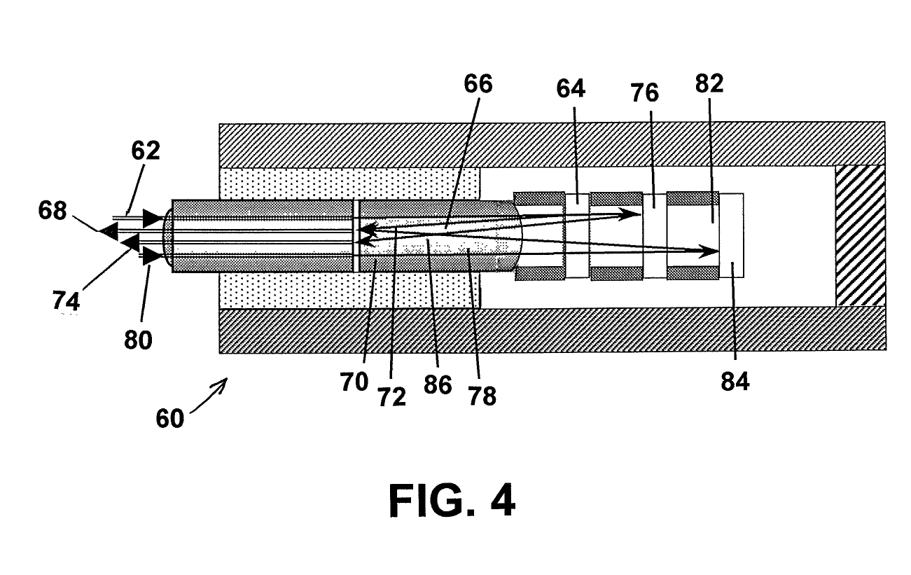

FIG. 4 illustrates a 4-fiber package in the form of an add-drop device 60. The device illustrated in FIG. 4 is an integrated add-drop device. First input light enters fiber 62, passes through the collimating lens 70 and contacts the first filter element 64. The beam is split into a first reflected and first transmitted beam. The first reflected beam is aligned to go back through the collimating lens 70 and into output fiber 68. The first transmitted beam contacts filter element 76 and is reflected back through filter element 64, through collimating lens 70 and into fiber 74. Second input light 80, passed through collimating lens 70, is transmitted through filter element 64, transmitted through filter element 76 and reflected by filter element 84 as beam 86 back through filter elements 76 and 64 and into fiber 68. Other examples of 4-port devices include 2-channel NWDM or CWDM, Tree coupler.

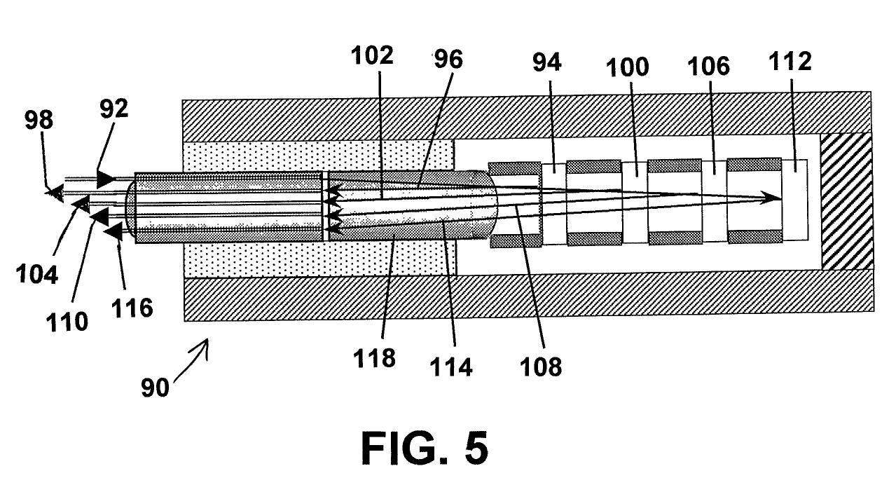

FIG. 5 illustrates a 5-fiber package in the form of a 4-channel CWDM device 90. Light is input through fiber 92 and passes through collimating lens 118. The beam contacts the first filter element 94 and is split into two beams, a first reflected beam and first transmitted beam. The first reflected beam 96 passes back through collimating lens 118 and into a channel output fiber 98. The first transmitted beam contacts the second filter element 100 where the beam is split into two beams, a second reflected beam and a second transmitted beam. The second reflected beam 102 passes back through first filter element 94 and passes back through collimating lens 118 and into a channel output fiber 104. The second transmitted beam contacts the third filter element 106, the beam is split into two beams, a third reflected beam and a third transmitted beam. The third reflected beam 108 passes back through second filter element 100, then passes through the first filter element 94 and passes back through collimating lens 118 and into a channel output fiber 110. The third transmitted beam contacts the fourth filter element 112. The beam is reflected. The fourth reflected beam 114 passes back through third filter element 106 and passes back through the second filter element 100, then passes through the first filter element 94 and passes back through collimating lens 118 and into a channel output fiber 116.

Having thus disclosed preferred embodiments of the invention, it being understood that various modifications and additions are contemplated and that the scope of protection afforded hereby is limited only by the appended claims and their equivalent.

What is claimed is:

1. An optical filtering device having an optical input and first and second optical outputs, the first optical output being spectrally identical to the optical input, the second optical output being spectrally different from the optical input; the device comprising:
a three fiber-ferrule telescopically embedded in an insulated glass tube for carrying said optical input and said first and second optical outputs;
an optical collimating lens at least partially telescopically embedded in said insulated glass tube;
said insulated glass tubes and said collimating lens being joined in axially abutting relation;
a filter element and a reflecting element both axially aligned with said collimating lens
for receiving said optical input and generating said first and second optical outputs.

2. The optical filtering device recited in claim 1 wherein said lens and said filter element are joined by a first glass holder.

3. The optical filtering device recited in claim 2 wherein said reflecting element and said filter element are joined by a second glass holder.

4. The optical filtering device recited in claim 3 wherein said first glass holder is joined to said filter element and to said lens by an adhesive.

5. The optical filtering device recited in claim 3 wherein said second glass holder is joined to said filter element and to said reflecting element by an adhesive.

6. The optical filtering device recited in claim 1 further comprising an outer glass tube in contiguous surrounding engagement with said insulating glass tube and extending to surround said filter element and said reflecting element.

7. The optical filtering device recited in claim 6 further comprising a plug enclosing an axial end of said outer glass tube beyond said reflecting element.

8. The optical filtering device recited in claim 5 where when each element is joined to another element by an adhesive, such adhesive being formed as a ring of adhesive centered around the optical axis of both such elements.

9. The optical filtering device recited in claim 6 wherein said glass tubes are made of thermally matched materials.

10. An optical filtering device having an optical input and first and second optical outputs, the first optical output being spectrally identical to the optical input, the second optical output being spectrally different from the optical input; the device comprising:
a three fiber-ferrule telescopically embedded in an insulated glass tube for carrying said optical input and said first and second optical outputs; and
a collimating lens telescopically embedded in said insulted glass tube in axial alignment with said three fiber-ferrule, said insulated glass tube being enclosed by an outer glass tube;
a filter element and a reflecting element in axial alignment with said collimating lens and being joined to each other by a holder interface.

11. The optical filtering device recited in claim 10 wherein said filter element is spherically shaped.

12. The optical filtering device recited in claim 10 wherein said outer glass tube is axially plugged beyond said reflecting element.

13. The optical filtering device recited in claim 10 further comprising adhesive in the form of respective rings positioned between axially abutting ends of said holder interface and said filter element and said reflecting element.

14. The optical filtering device recited in claim 10 wherein said insulated glass tube and said outer glass tube are made of thermally matched materials.

15. The optical filtering device recited in claim 10 wherein said insulated and outer glass tubes are made of identical glass materials.

16. A method of fabricating an optical filtering device, the device having an optical input and first and second optical outputs, the first optical output being spectrally identical to the optical input, the second optical output being spectrally different from the optical input, the method comprising the steps of:
a) providing a plurality of insulating glass tubes of different diameter;
b) telescopically embedding a three fiber-ferrule in a smaller one of said tubes;
c) telescopically embedding a collimating lens in said smaller one of said tubes;
d) joining said tubes in radial abutting relation; said smaller one of said tubes being contained a larger one of said tubes;
e) attaching a filter element and reflecting element in axial alignment with said collimating lens; and
f) plugging said larger one of said tubes.

17. An optical device having an optical input and optical output, the optical output being spectrally identical to the optical input; the device comprising:
a two fiber-ferrule telescopically embedded in an insulated glass tube for carrying said optical input and said optical output;
an optical collimating lens at least partially telescopically embedded in said insulated glass tube;
said insulated glass tubes and said collimating lens being joined in axially abutting relation;
a filter element axially aligned with said collimating lens for receiving said optical input and generating said optical output, said filter also generating a filtered output.

18. The optical device recited in claim 17 wherein said lens and said filter element are joined by a glass holder.

19. The optical device recited in claim 18 wherein said glass holder is joined to said filter element and to said lens by an adhesive.

20. The optical device recited in claim 17 further comprising a photo detector axially aligned with said filter element and wherein said filtered output is input to said photo detector.

21. The optical filtering device recited in claim 17 further comprising an outer glass tube in contiguous surrounding engagement with said insulating glass tube and extending to surround said filter element.

22. The optical device recited in claim 21 further comprising a plug enclosing an axial end of said outer glass tube beyond said filter element.

23. The optical device recited in claim 19 where when each element is joined to another element by an adhesive, such adhesive being formed as a ring of adhesive centered around the optical axis of both such elements.

24. The optical device recited in claim 22 wherein said glass tubes are made of thermally matched materials.

25. An optical filtering device having an optical input and first and second optical outputs, the first optical output being spectrally identical to the optical input, the second optical output being spectrally different from the optical input; the device comprising:
a two fiber-ferrule telescopically embedded in an insulated glass tube for carrying said optical input and said first optical output;
a collimating lens telescopically embedded in said insulted glass tube in axial alignment with said two fiber-ferrule, said insulated glass tube being enclosed by an outer glass tube;
a filter element in axial alignment with said collimating lens and being joined to said lens by a holder interface; and
a receiving device receiving said second optical output.

26. The optical filtering device recited in claim 25 wherein said outer glass tube is axially plugged beyond said receiving device.

27. The optical filtering device recited in claim 25 further comprising adhesive in the form of respective rings positioned between axially abutting ends of said holder interface and said filter element.

28. The optical filtering device recited in claim 25 wherein said insulated glass tube and said outer glass tube are made of thermally matched materials.

29. The optical filtering device recited in claim 25 wherein said insulated and outer glass tubes are made of identical glass materials.

30. A method of fabricating an optical filtering device, the device having an optical input and a plurality of optical outputs, a first optical output being spectrally identical to the optical input, the remaining optical outputs being spectrally different from the optical input, the method comprising the steps of:
a) providing a plurality of insulating glass tubes of different diameter;
b) telescopically embedding a multiple fiber-ferrule in a smaller one of said tubes;
claim 30. Continued
c) telescopically embedding a collimating lens in said smaller one of said tubes;
d) joining said tubes in radial abutting relation; said smaller one of said tubes being contained a larger one of said tubes;
e) attaching a plurality of filter elements in axial alignment with said collimating lens; and
f) plugging said larger one of said tubes.

31. An optical filtering device having an optical input and multiple optical outputs, a first optical output being spectrally identical to the optical input, the remaining optical outputs being spectrally different from the optical input; the device comprising:
a multiple fiber-ferrule telescopically embedded in an insulated glass tube for carrying said optical input and said optical outputs;
an optical collimating lens at least partially telescopically embedded in said insulated glass tube;
claim 31. Continued
said insulated glass tubes and said collimating lens being joined in axially abutting relation;
a plurality of filter elements axially aligned with said collimating lens for receiving said optical input and generating said optical outputs.

32. The optical filtering device recited in claim 31 wherein said lens and said filter elements are joined by respective glass holders.

33. The optical filtering device recited in claim 32 wherein each said glass holder is joined to a filter element by an adhesive.

34. The optical filtering device recited in claim 31 further comprising an outer glass tube in contiguous surrounding engagement with said insulating glass tube and extending to surround said filter elements.

35. The optical filtering device recited in claim 34 further comprising a plug enclosing an axial end of said outer glass tube beyond said filter elements.

36. The optical filtering device recited in claim 31 where when each element is joined to another element by an adhesive, such adhesive being formed as a ring of adhesive centered around the optical axis of both such elements.

37. The optical filtering device recited in claim 34 wherein said glass tubes are made of thermally matched materials.

38. An optical filtering device having an optical input and a plurality of optical outputs, a first optical output being spectrally identical to the optical input, the remaining optical outputs being spectrally different from the optical input; the device comprising:
a multiple fiber-ferrule telescopically embedded in an insulated glass tube for carrying said optical input and said optical outputs; and
claim 38. Continued
a collimating lens telescopically embedded in said insulted glass tube in axial alignment with said multiple fiber-ferrule, said insulated glass tube being enclosed by an outer glass tube;
at least one filter element in axial alignment with said collimating lens and being joined to said lens by a holder interface.

39. The optical filtering device recited in claim 38 wherein said outer glass tube is axially plugged beyond said filter element.

40. The optical filtering device recited in claim 38 further comprising adhesive in the form of respective rings positioned between axially abutting ends of said holder interface and said filter element.

41. The optical filtering device recited in claim 38 wherein said insulated glass tube and said outer glass tube are made of thermally matched materials.

42. The optical filtering device recited in claim 38 wherein said insulated and outer glass tubes are made of identical glass materials.
